(19) United States
(12) Patent Application Publication
(10) Pub. No.: US 2008/0013303 A1
(43) Pub. Date: Jan. 17, 2008

(54) Entryway Illumination System And Method

(76) Inventor: David A. Guarino, Kenmore, NY (US)

Correspondence Address: HODGSON RUSS LLP;THE GUARANTY BUILDING, 140 PEARL STREET, SUITE 100, BUFFALO, NY, 14202-4040, US

(21) Appl. No.: 11/778,285

(22) Filed: Jul. 16, 2007

Related U.S. Application Data
(60) Provisional application No. 60/830,887, filed on Jul. 14, 2006.

(51) Int. Cl. F21S 8/00

(52) U.S. Cl. 362/145

(57) ABSTRACT

An entryway illumination system comprising jambs and a header and a lighting assembly mounted on one of the jambs. The lighting assembly includes a mounting bracket with spaced apart first and second flanges, and a lamp housing with first and second locking walls. The first and second flanges engage the first and second locking walls such that the mounting bracket and lamp housing are joined. The lighting assembly includes a light emitting element for providing light, and a transmittive-protective cover for covering the light emitting element is joined to the lamp housing. The transmittive protective cover may be clear, or the transmittive-protective cover may have a color such that light emitted from the transmittive-protective cover has a color. In another embodiment there is a recessed entryway illumination system with a lighting assembly received in an opening in one of the jambs.

### CROSS REFERENCE TO RELATED APPLICATION

This application claims priority to U.S. provisional patent application Ser. No. 60/830,887, filed Jul. 14, 2006 to Guarino, for an Entryway Illumination System, the contents of which are hereby incorporated by reference.

### BACKGROUND

In the prior art there are lamps that are mounted on the exterior sides of a dwelling or other building and which emit light that shines on the approach to the house. However, these lamps do not provide sufficient light to the door panel or the door jambs, because the light is directed toward the approach and the areas surrounding the approach. This may be problematic because insufficient light is directed to the door and doorknob. In addition, an arrangement such as that found in the prior art is not aesthetically pleasing because the door and door jambs are poorly illuminated.

Therefore, it would be desirable to illuminate the entryway of a house or other building with light that is primarily directed to the door jambs, and possibly other parts of the door.

### SUMMARY

An entryway illumination system according to the invention may include two door jambs, a header and lighting assemblies with light emitting elements mounted on or recessed into the door jambs. The entryway illumination system may also include a lighting assembly mounted on the header. In another embodiment, the lighting assemblies may be mounted on a storm door.

Each lighting assembly may include a lamp housing in which the light emitting element resides, and a mounting bracket with spaced apart first and second flanges. The lamp housing may have first and second locking walls and the first and second flanges of the mounting bracket may engage the first and second locking walls to join the lamp housing with the mounting bracket. A transmittive-protective cover may be joined to the lamp housing in order to cover and protect the light emitting element. The transmittive-protective cover may be clear, or may be colored such that light that is emitted from the transmittive-protective cover is colored. The light emitting element is connected to a power source, which may include a low voltage transformer, and may illuminate the door jambs, door, header, threshold and door panel. The lighting assemblies mounted to the door jambs are easily accessed and can be maintained without the use of a ladder.

In another embodiment the lighting assemblies are received in openings in the door jambs. The header may also have openings for receiving lighting assemblies. The lighting assembly includes a lamp housing with a base member having opposed internal and external surfaces and a wire opening. A socket assembly may extend from the internal surface and may receive a light emitting element, for example, an incandescent bulb. A surrounding wall may extend from the housing base member to a housing edge, and a housing flange may extend outwardly from the housing edge. The lighting assembly may include a transmittive-protective cover, and the transmittive-protective cover may be pressed on the housing flange. The transmittive-protective cover may be clear, or may be colored such that light emitted from the transmittive-protective cover is colored. The light emitting element is connected to a power source, which may include a low voltage transformer. The light emitting element may illuminate the door jambs, door, header, threshold and door panel. The lighting assemblies received in the door jambs are easily accessed and can be maintained without the use of a ladder.

The following detailed description, when read in conjunction with the accompanying drawings, is in such full, clear, concise and exact terms as to enable any person skilled in the art to which it pertains, or with which it is mostly nearly connected, to make and use the entryway illumination system.

### BRIEF DESCRIPTION OF THE DRAWINGS

FIG. 1A is a cross-sectional view illustrating an entryway illumination system according to a surface mounted embodiment of the invention;

FIG. 1B is a partial plan view of a lighting assembly and mounting bracket of FIG. 1A;

FIG. 2 is an elevational view of an entryway provided with a surface mounted embodiment of the invention;

FIG. 2A is an elevational view of an entryway with a surface mounted embodiment of the invention depicting lighting assemblies positioned different distances from a header;

FIG. 3 is an elevational view of a portion of the entryway shown in FIG. 2;

FIG. 4 is a sectional view showing a portion of the entryway header depicted in FIG. 2, taken along line A-A shown in FIG. 3;

FIG. 5 is a sectional view showing a portion of the entryway door jamb of the entryway depicted in FIG. 2, taken along the line B-B shown in FIG. 3;

FIG. 6 is a cross-sectional view illustrating a portion of the system of the illumination system according to a recess mounted embodiment of the invention;

FIG. 7 is an elevational view of an entryway provided with a recess mounted illumination system according to the invention;

FIG. 7A is an elevational view of an entryway provided with a recess mounted illumination system depicting lighting assemblies mounted different distances from a header;

FIG. 8 is an elevational view of a portion of the entryway shown in FIG. 7;

FIG. 9 is a sectional view showing a portion of the entryway header, taken along the line C-C shown in FIG. 8;

FIG. 10 is a sectional view showing a portion of the entryway doorjamb, taken along the line D-D shown in FIG. 8;

FIG. 11 is a schematic circuit diagram for alternating current powered lamps in a system according to the invention;

FIG. 12 is a schematic circuit diagram for direct current powered lamps in a system according to the invention;

FIG. 13 is a photo of an entryway taken with flash photography showing illumination of an entryway using a prior art system;

FIG. 14 is a photo of the entryway of FIG. 13 taken without flash photography;

FIG. 15 is a photo of the entryway taken with flash photography showing illumination of the entryway of FIG. 13, but using an illumination system according to the invention; and

FIG. 16 is a photo of the entryway of FIG. 15 taken without flash photography.

### DESCRIPTION

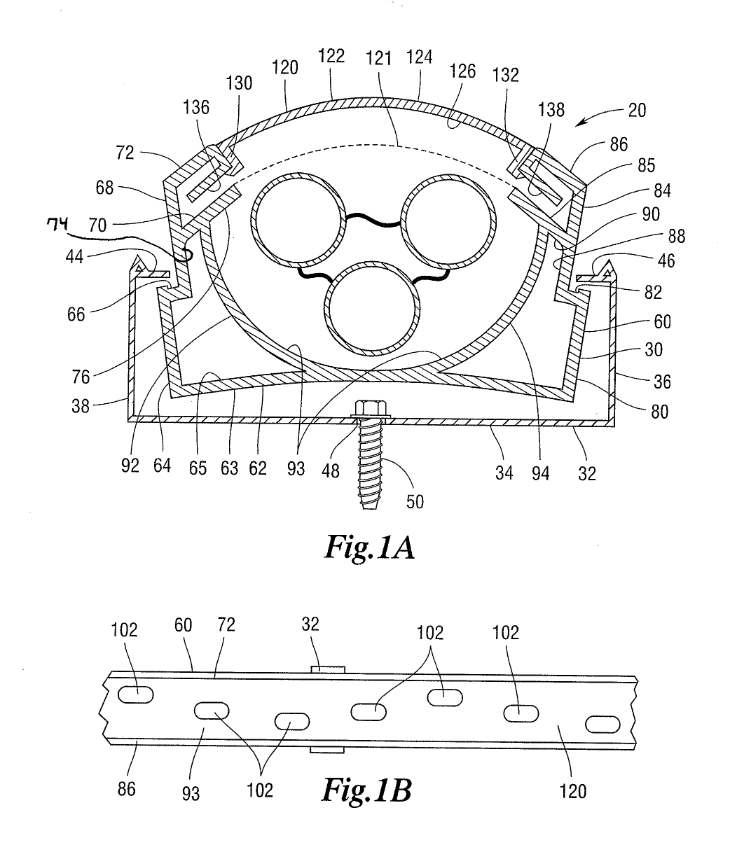

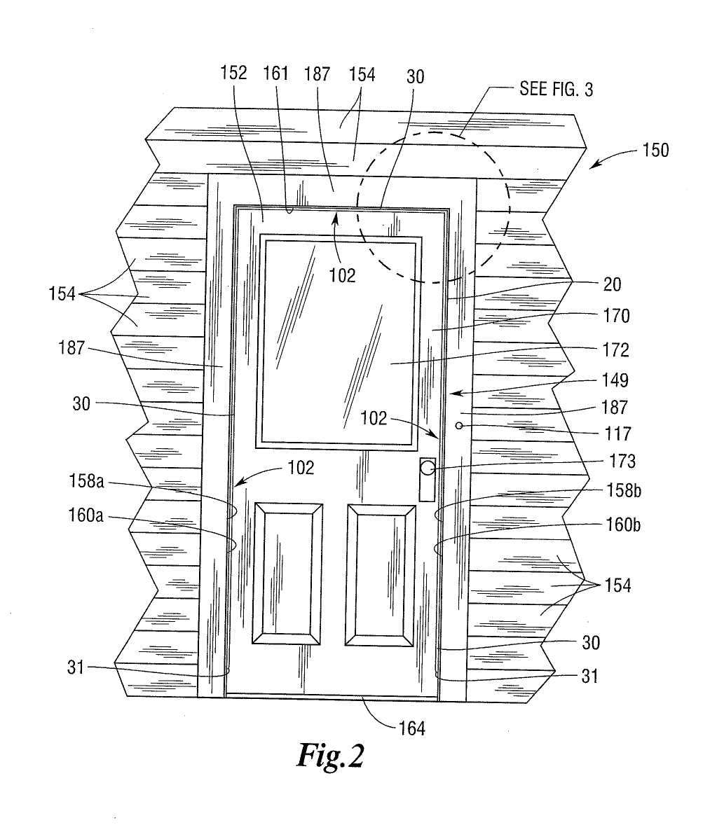

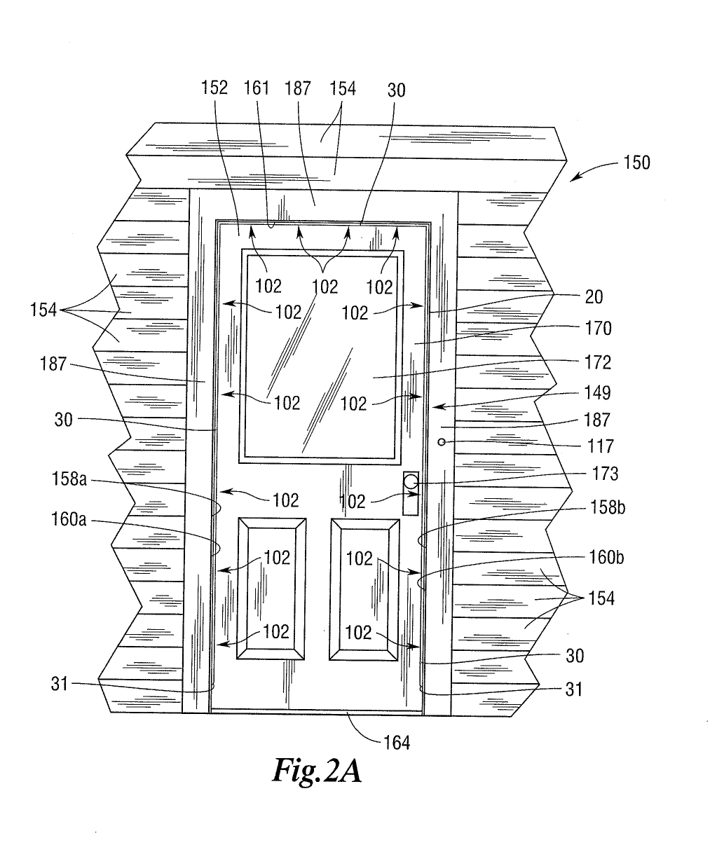

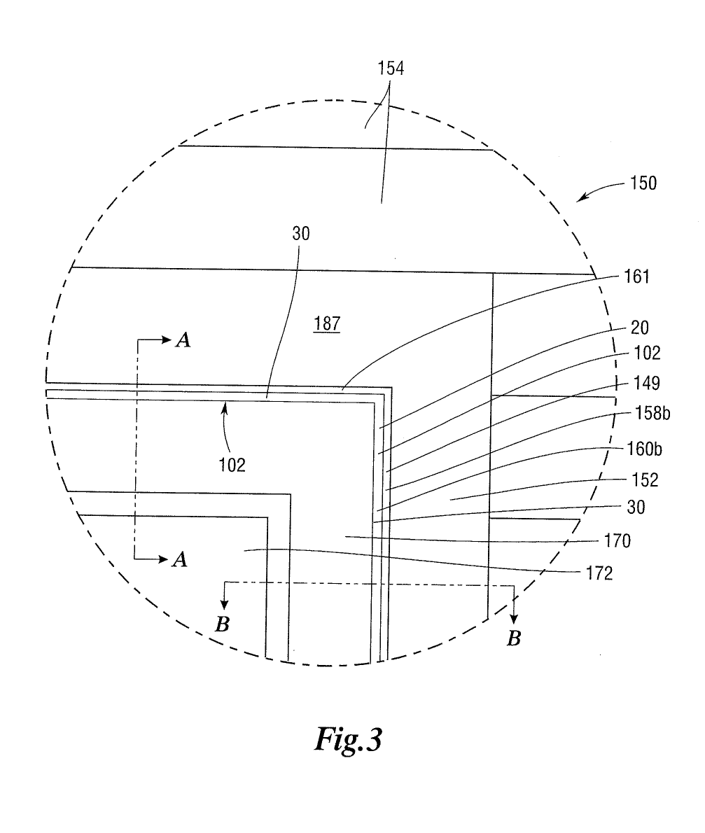

An entryway illumination system 20 according to the invention is shown in FIGS. 1-5. With reference to FIG. 1a, the entryway illumination system 20 may include a mounting bracket 32 and a lighting assembly 30 that is received in the mounting bracket 32. The mounting bracket 32 is shown having a base 34 and spaced apart first and second sidewalls 36, 38, respectively, that extend from the base 34. The first and second sidewalls 36, 38, face one another and may be perpendicular to the base 34 and may be parallel to one another. The first and second sidewalls 36, 38 extend to first and second flanges 44, 46, respectively, which are spaced apart from one another. The first flange 44 and the second flange 46 extend over the base 34, and may be perpendicular or sloped relative to the first and second sidewalls 36, 38, respectively. The base 34 may have a fastener opening 48 through which a fastener 50, for example a screw or nail, is passed such that the mounting bracket 32 can be connected to first and second door jambs 158a, 158b, respectively, or a header 161, see FIGS. 2, 4 and 5.

The lighting assembly 30 may further include a lamp housing 60 that is disposed in the mounting bracket 32. The lamp housing 60 is shown with a lamp housing base 62 having opposed first and second base sides 63, 65, respectively. The lamp housing base 62 may be curved in a direction away from the mounting bracket base 34 (see FIG. 1A). Power supply conductors 103, such as wires, supply electricity to light emitting elements 102 located in the lamp housing 60, and the wires or conductors may extend parallel to the lamp housing 60.

The lamp housing base 62 has extending therefrom a first lamp housing sidewall 64 which extends in a direction away from the lamp housing base 62 to a first locking wall 66. The first locking wall 66 may be joined to a second lamp housing sidewall 68. First and second lamp housing flanges 70, 72, respectively extend from an inner surface 74 of the second lamp housing sidewall 68. The second lamp housing flange 72 is a greater distance from the lamp housing base 62 than the first lamp housing flange 70. The first lamp housing flange 70 has an inner surface 76. The lamp housing base 62 has a third lamp housing sidewall 80 that extends therefrom. The housing sidewall 80 faces the first lamp housing sidewall 64. The third lamp housing sidewall 80 extends to a second locking wall 82. The second locking wall 82 is joined to a fourth lamp housing sidewall 84 which faces the second lamp housing sidewall 68. Third and fourth lamp housing flanges 85, 86, respectively, extend from an inner side 88 of the fourth lamp housing sidewall 84. The fourth lamp housing flange 86 is a greater distance from the lamp housing base 62 than the third lamp housing flange 85. And, the third lamp housing flange 85 has an inner surface 90. The first lamp housing flange 70 faces the third lamp housing flange 85, and the second lamp housing flange 72 faces the fourth lamp housing flange 86.

The lamp housing 60 further includes a first curved wall 92 that extends from the inner surface 76 of the first lamp housing flange 70 to the second base side 65, and a second curved wall 94 extends from the inner surface 90 of the third lamp housing flange 85 to the second base side 65. It is pointed out that the lamp housing 60 and bracket 36 can be made of plastic, metal and wood and combinations thereof, and may be flexible. The lighting assembly 30 further includes at least one light emitting element 102 that is disposed in the lamp housing 60. The light emitting elements 102 may be connected by conductors 103, such as wires, to a power source. The conductors 103 may extend parallel to the lamp housing 60 in order that the light emitting elements 102 may be readily connected to the conductors 103. Methods of installing light emitting elements 102 and wiring light emitting elements 102 to a power source are well known to those having ordinary skill in the art and will not be detailed herein. The light emitting elements 102 may be, but are not limited to, incandescent, fluorescent, fiber optic, light-emitting diode (LED), halogen or neon lighting devices. In addition, the first and second curved walls 92, 94, respectively, may include a reflective material 93, for example a reflective layer, that faces the light emitting element 102, in order to more evenly distribute and reflect light emitted from the light emitting elements 102. The reflective material 93 may include a metal, for example aluminum, or other reflective material.

The lighting assembly 30 includes a transmittive-protective cover 120 for protecting the light emitting elements 102. The transmittive-protective cover 120 may be removable. Light from the light emitting elements 102 is capable of passing through the transmittive-protective cover 120. The transmittive-protective cover 120 is releasably joined to the lamp housing 60. The transmittive-protective cover 120 has a cover wall 122 that covers the lamp housing 60. The cover wall 122 may have a curved cross section opposed convex and concave surfaces 124, 126, respectively. The cover wall 122 is shown with first and second lateral edge walls 130, 132, respectively. A first securing wall 136 extends from the first lateral edge wall 130, and a second securing wall 138 extends from the second lateral edge wall 132. In addition, with reference to FIG. 1A, the dashed lines indicate the outline of a sealing cover 121 that may be permanently joined to the lamp housing 60. In an embodiment where the sealing cover 121 is joined to the lamp housing 60, the transmittive-protective cover 120 may or may not be used. The sealing cover 121 allows light to pass through, and may be clear or have a color.

The transmittive-protective cover 120 can be slid on and off of the lamp housing 60 or snapped on and off of the lamp housing 60. For example, when the transmittive-protective cover 120 is joined to the lamp housing 60, the first securing wall 136 is disposed between the first and second lamp housing flanges 70, 72, respectively, and the second securing wall 138 is disposed between the third and fourth lamp housing flanges 85, 86, respectively, such that the transmittive-protective cover 120 is releasably joined to the lamp housing 120.

The above-described arrangement allows for the transmittive-protective cover 120 to be interchangeable with other transmittive-protective covers. The transmittive-protective cover 120 may be clear and light can pass through the transmittive-protective cover 120. The transmittive-protective cover 120 may be translucent. The transmittive-protective cover 120 may be made of plastic, glass or other suitable material. The transmittive-protective cover 120 may also have a color, for example the transmittive-protective cover 120 may be green or red and used during different seasons of the year. If the transmittive-protective cover 120 has a color, then the light emitted by the light emitting elements 102 may pass through the transmittive-protective cover 120 such that the light emitted from the transmittive-protective cover 120 is the same color as the transmittive-protective cover 120. It is pointed out that in other embodiments (not shown) the transmittive-protective cover may be flat or concave, or may be made to have a pattern.

FIGS. 2, 3 and 5 show that one of the lighting assemblies 30 may be mounted on each of the first and second door jambs 158a, 158b, respectively, and mounted on the header 161, as shown in FIGS. 2, 3, and 4. With reference to FIG. 2, the lighting assemblies 30 mounted on the first and second door jambs 158a, 158b, stop before reaching threshold 164, but may be embodied to extend to the threshold 164. The lighting assemblies 30 may have end caps 31 to shield the lighting assemblies 30 from the weather. The conductors 103 connect to the power source in the vicinity of the end caps 31. In other embodiments, the lighting assemblies 30 on the first and second door jambs 158a, 158b, may stop before reaching the header 161. In other embodiments, only the first and second door jambs 158a, 158b, have lighting assemblies 30 mounted to them, or only one of the first and second door jambs 158a, 158b, has a lighting assembly 30 mounted thereon.

The entryway illumination system 20 may be installed in the entryway 149 of a house 150 or other building. With reference to FIGS. 2 and 5, the first and second door jambs 158a, 158b are shown spaced from one another and have facing first and second door jamb surfaces 160a, 160b, respectively. The header 161 has a header surface 162 that extends between the first and second door jambs 158a, 158b, respectively, and faces the threshold 164. The header 161 extends in a direction perpendicular to the direction in which the first and second jambs 158a, 158b extend. The first and second door jambs 158a, 158b, header 161 and threshold 164 define the entryway 149, which is a passageway that leads to the interior of the dwelling or other building 150. It is to be understood that the entryway illumination system 20 may also be used for illuminating virtually any entryway, for example it may used to illuminate garage door entryways, and window entryways.

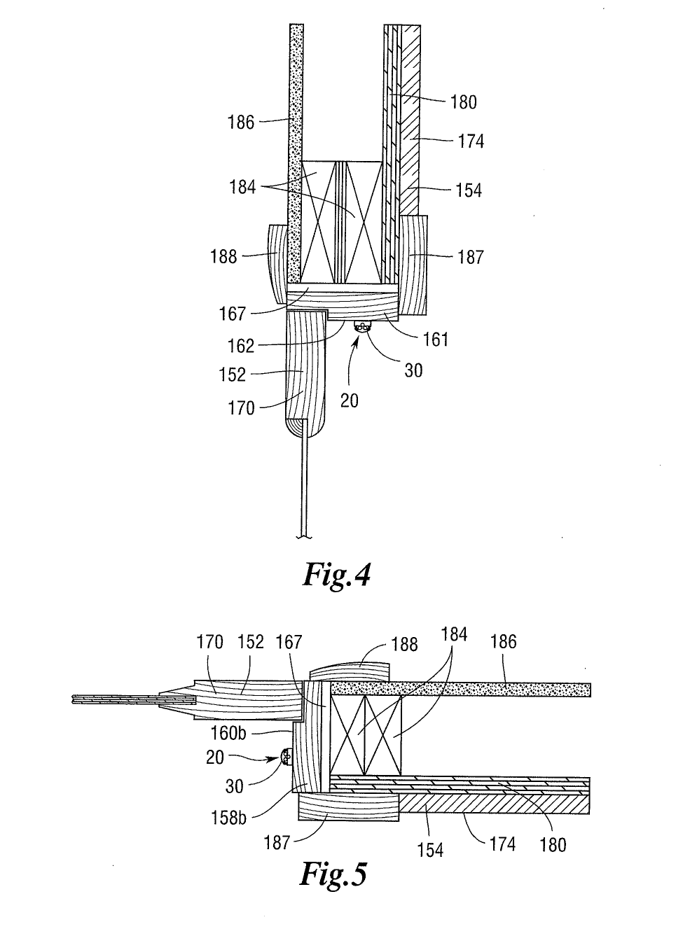

With reference to FIGS. 2-5, the house 150 has exterior siding 154 that extends to and abuts against the exterior door trim 187. The exterior door trim 187 extends to and abuts against the first and second door jambs 158a, 158b. A door 152 provides access through the entryway 149 and is hinged to the house 150 in a known manner. The door 152 has a door slab 170 and may have glazing 172 and a doorknob 173. In addition, as shown in the sectional views of FIGS. 4 and 5, the house 150 has house walls 174 that include (working from the outside of the house to the inside of the house) the following: exterior siding 154, exterior sheathing 180, framing members 184 and interior drywall 186 that abuts against interior door trim 188. The exterior siding 154 abuts against the exterior door trim 187. With reference to FIG. 5, the door jambs 158a, 158b, extend between the exterior door trim 187 and interior door trim 188. Similarly, with reference to FIG. 4, the header 161 extends between the exterior door trim 187 and interior door trim 188. The house walls 174 define wall spaces 177. The structural configuration of a house is well known to those having ordinary skill in the art and therefore will not be further described.

To use, the mounting brackets 36 may be connected with fasteners 50 to the first and second doorjamb surfaces 160a, 160b, and header surface 162. Next, lamp housings 60 may be moved into the mounting brackets 36. This can be accomplished by snapping the lamp housings 60 into the brackets 36 such that the first and second flanges 44, 46, are disposed vertically above the first and second locking walls 66, 82 (see FIG. 1A), thus holding the lamp housings 60 to the brackets 36. Or, the first and second locking walls 66, 82, can be slid under the first and second flanges 44, 46, such that the lamp housings 60 are held in place on the brackets 36. The lamp housing 60 may be at least partly disposed in the mounting bracket 36. The lighting elements 102 are positioned in the lamp housing 60 and the conductors 103 may be connected to the power source. The transmittive-protective cover 120 may be fitted on the lamp housing 60.

In addition, the light emitting elements 102 on the facing first and second door jambs 158a, 158b may be offset relative to one another, such that the distances the light emitting elements 102 on the first doorjamb 158a are from the header 161 are different than the distances the light emitting elements 102 on the second door jamb 158b are from the header 161. For example, there may be four light emitting elements 102 disposed in the lamp housing 60 mounted on the first doorjamb 158a, and five light emitting elements 102 disposed in the lamp housing 60 on the second doorjamb 158b each being positioned a different distance from the header 161 (see FIG. 2A). In this manner the light emitting elements 102 are offset from one another. Offsetting the light emitting elements 102 may prevent the light that is emitted from forming scalloped patterns on the door 152, thereby achieving a more even illumination of the door 152 and the door jambs 158a, 158b. In another embodiment, no lighting assembly 30 is mounted on the header 161, such that the door 152 is illuminated by the lighting assemblies 30 mounted on the first and second door jambs 158a, 158b. Such an arrangement allows the lighting assemblies 30 to be readily maintained by a person standing on the ground, thus eliminating the need for a ladder. The light emitting elements 102 may be small and advantageously have low power requirements, which achieves a more even illumination of the door 152 and reduces power requirements.

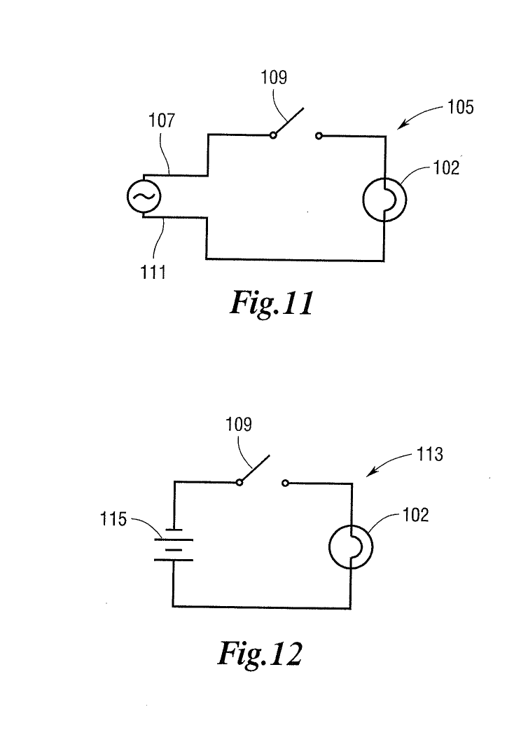

FIG. 11 shows a schematic circuit diagram for an alternating current (AC) circuit 105 for powering light emitting elements 102. The AC circuit 105 has a supply wires 107, 111, a switch 109, and a light emitting element 102. FIG. 12 shows a schematic circuit diagram for a direct current (DC) circuit 113 for powering light emitting elements 102. The direct current circuit 113 includes a battery 115 for providing electrical power, a switch 109, and a light emitting element 102. AC circuits 105 and DC circuits 113 are well known to those having ordinary skill in the art and therefore will not be further explained herein. The light emitting elements 102 can be switched on and off as desired using the switch 109. There may also be a photocell switching device 117 mounted on the second door jamb 158b (see FIG. 2), that is in electronic communication with the switch 109. The photocell switching device 117 detects ambient light and turns the light emitting elements 102 on and off in accordance with the intensity or level of the ambient light detected. The photocell switching device 117 may be mounted on the house wall 174. Photocell switching devices 117 are well known to those having ordinary skill in the art and therefore will not be explained further herein.

When the switch 109 is closed, current is allowed to flow to the light emitting elements 102. With electricity flowing to the lighting assembly 30 mounted on the first doorjamb surface 160a of the first doorjamb 158a, the light emitting elements 102 emit light, which illuminates the facing second door jamb surface 160b, and to some extent, the header surface 162, the door 152 and the threshold 164. With electricity flowing to the lighting assembly 30 mounted on the second doorjamb surface 160b of the second doorjamb 158b, the light emitting elements 102 emit light, which illuminates the facing first door jamb surface 160a, and to some extent, the header surface 162, the door 152 and the threshold 164. If there are lighting assemblies 30 mounted on the header 161, then they would emit light and illuminate the threshold 164, and to some extent, the door 152, and the first and second door jamb surfaces 160a, 160b. Thus, one of the advantages of the entryway illumination system 20 is that the entryway 149 is fully illuminated by the lighting assemblies 30, which provides for an aesthetically pleasing and inviting entryway 149 that is completely illuminated. As another advantage the doorknob 173 is illuminated making opening and locking (and unlocking) the door 152 easier, especially at night.

In addition, the first and second door jambs 158a, 158b, and header 161 may each be pre-assembled at a factory (not shown) with the light emitting assemblies 30, such that they are readily available for use during construction of the house 150.

It is pointed out that the illumination system 20 can be installed on the headers, thresholds and jambs, window sills, and can be installed around garage door entryways, skylights, etc. In addition, the entryway illumination system 20 may be installed on a permanent or temporary basis. It may also be installed so as to be removed and reinstalled quickly in order to allow full access to the entire opening of the entryway if necessary. In the case that it would need to be removed quickly, the lamp housing 60 may be removed from the mounting bracket 32, such that only the mounting bracket 32 remains attached to the jamb. The conductors 103, which connect to a recessed wiring harness in the door jamb, are removed from the wiring harness, such that the lamp housing 60 may be moved. It is pointed out that the entryway illumination system 20 may be powered from either a permanent or portable (temporary) power source.

In addition, the entryway illumination system 20 is capable of accommodating different lighting scenarios so that it may be incorporated into alternate lighting schemes that may be employed throughout the year. For example, during holiday seasons the front of the house 150 may be illuminated with additional lighting systems having different colors. The entryway illumination system could be modified to match that system or to compliment that system by employing differently colored transmittive-protective covers 120 that emit differently colored light.

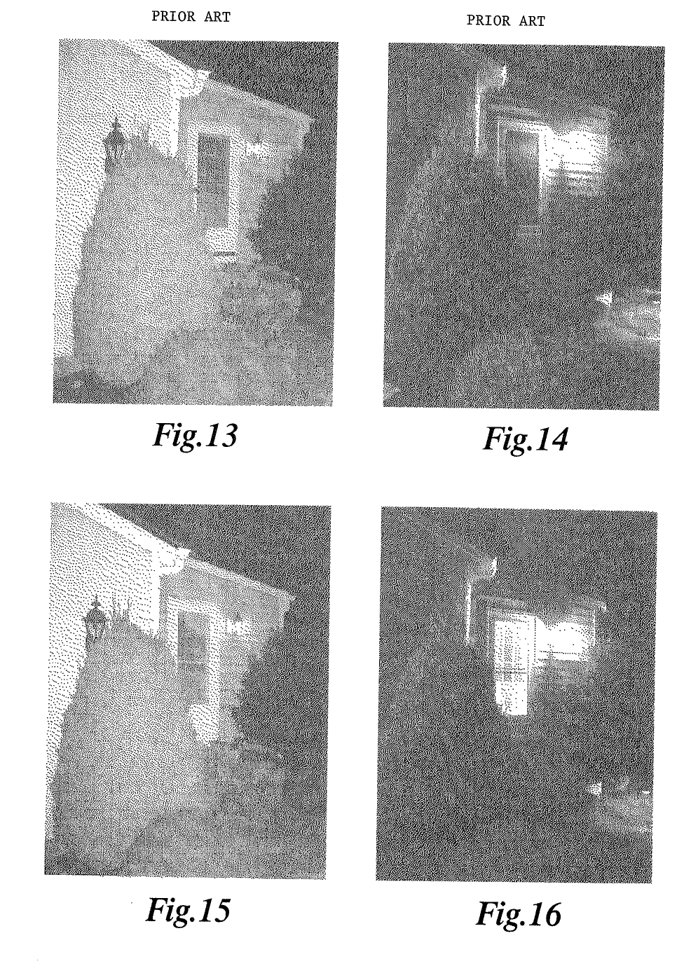

FIG. 13 shows a prior art way of illuminating an entryway 149 which consists of a lantern 300 mounted on the sidewall of the house 150. FIG. 13 was taken with a flash so that the entryway can be more easily seen in the figure. FIG. 15 shows the same entryway 149 when the entryway illumination system 20 is turned on. FIG. 14 shows the prior art way of illuminating taken without a flash, and thereby provides a better idea of how the entryway would appear to a person who is approaching the door 152. FIG. 16 shows entryway 149 when the entryway illumination system 20 according to the invention is turned on. The entryway illumination system 20 provides more light to the entryway 149, and presents a safer more inviting appearance.

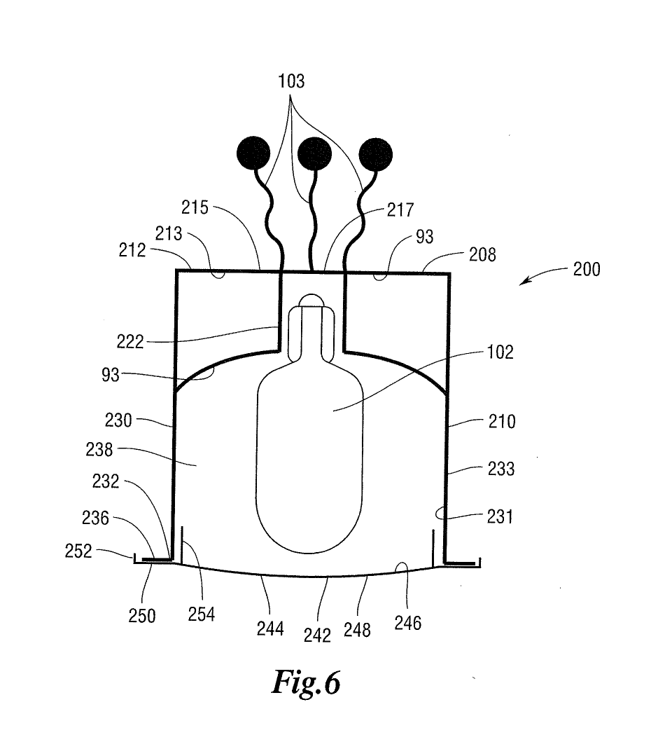

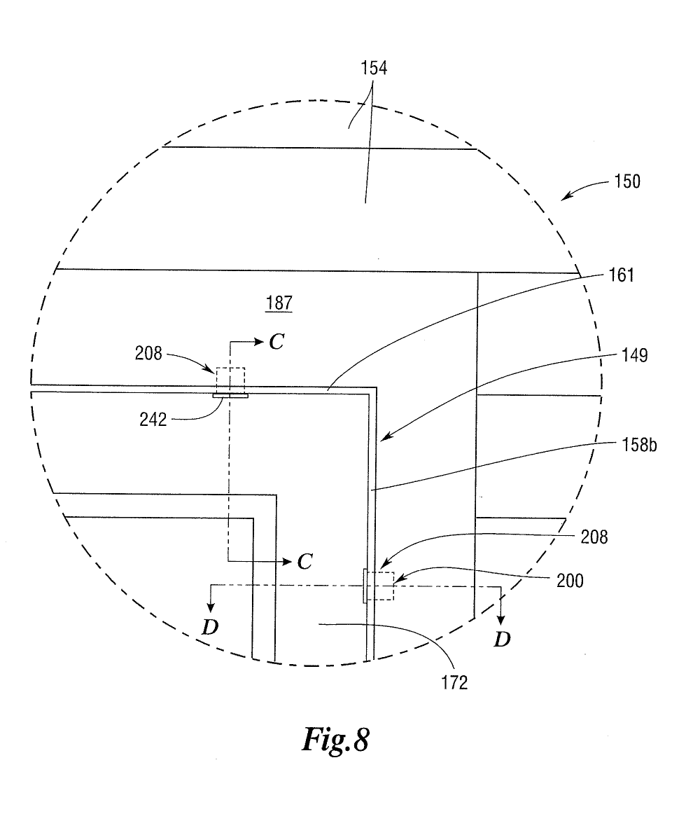

Another embodiment according to the invention is shown in FIGS. 6-10. There is shown a recessed entryway illumination system 200 comprising one or more lighting assemblies 208, each having a lamp housing 210. The lamp housing 210 has a housing member base 212 with opposed internal and external surfaces 213, 215, respectively. A conductor opening 217 is provided for receiving a conductor 103 therethrough. Extending from the internal surface 213 is a socket assembly 222 for receiving a light emitting element 102, in this case an incandescent bulb. The socket assembly 222 is connected to the conductors 103 and to a power source which provides electrical power to the light emitting element 102.

Extending from the housing base member 212 is a surrounding wall 230 which may have a circular cross section. The surrounding wall 230 has opposed internal and external surrounding wall surfaces 231, 233, respectively. The surrounding wall 230 extends from the housing base member 212 to a housing edge 232. A housing flange 236 extends outwardly from the housing edge 232. The housing flange 236 has a width designated W1 in FIG. 6. The surrounding wall 230 and housing base member 212 define a housing recess 238 sized to receive the light emitting element 102.

The lighting assembly 208 includes a transmittive-protective cover 242 having a curved portion 244 with opposed inner and outer surfaces 246, 248, respectively, as shown in FIG. 6. The curved portion 242 of the transmittive protective cover extends to a relatively flat portion 250. Extending from the inner surface 246 is a first cover flange 252 that extends in a direction away from the cover inner surface 246, and toward the base 212. A second cover flange 254 extends from the cover inner surface 246 and is disposed a distance designated W2 in FIG. 6 from the first cover flange 252. The second cover flange 254 extends from the cover inner surface 246 in a direction away from the cover inner surface 246 a greater distance as compared to the first cover flange 252. The distance W2 from the first cover flange 252 to the second cover flange 254 is greater than the distance W1. This allows the transmittive protective cover 242 to be releasably pressed onto the housing flange 236 such that the housing flange 236 is positioned between the first and second cover flanges 252, 254. Once the transmittive protective cover 242 is pressed over the housing flange 236, the transmittive-protective cover 242 may be held in place by a friction fit, by the use of an adhesive, or by providing flanges 252, 254 with threads that engage matching threads on the wall surface 231. The transmittive-protective cover 242 can be readily removed by prying it off of the housing flange 232.

The transmittive protective cover 242 can be glass or plastic or other suitable material, and may be clear. Light can pass through the transmittive protective cover 242. The transmittive protective cover 242 is interchangeable with other transmittive protective covers 242 that have different colors, such that light passing though the transmittive protective cover 224 is emitted in the color of the cover. The light emitting element 102 can be incandescent as shown, fluorescent, fiber optic, light-emitting diode (LED), halogen or neon light emitting element. In addition, the internal surface of the housing member base 212, and internal surrounding wall surface 231 may include a reflective material 93, for example a reflective layer, that faces the light emitting element 102, in order to more evenly distribute and reflect light emitted from the light emitting elements 102. The reflective material 93 may include a metal, for example aluminum, or other reflective material.

The recessed entryway illumination system 200 may be embodied with first and second door jambs 158a, 158b, and header 161 that extends between the first and second door jambs 158a, 158b, and may included a threshold 164 that faces the header 161, as described in connection with the first embodiment of the invention described above.

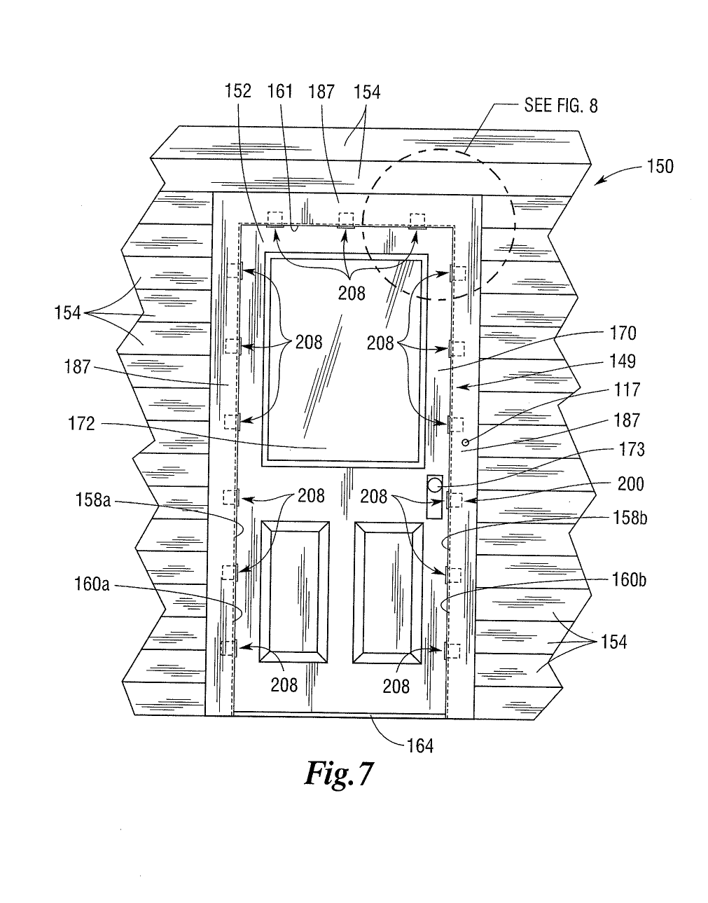

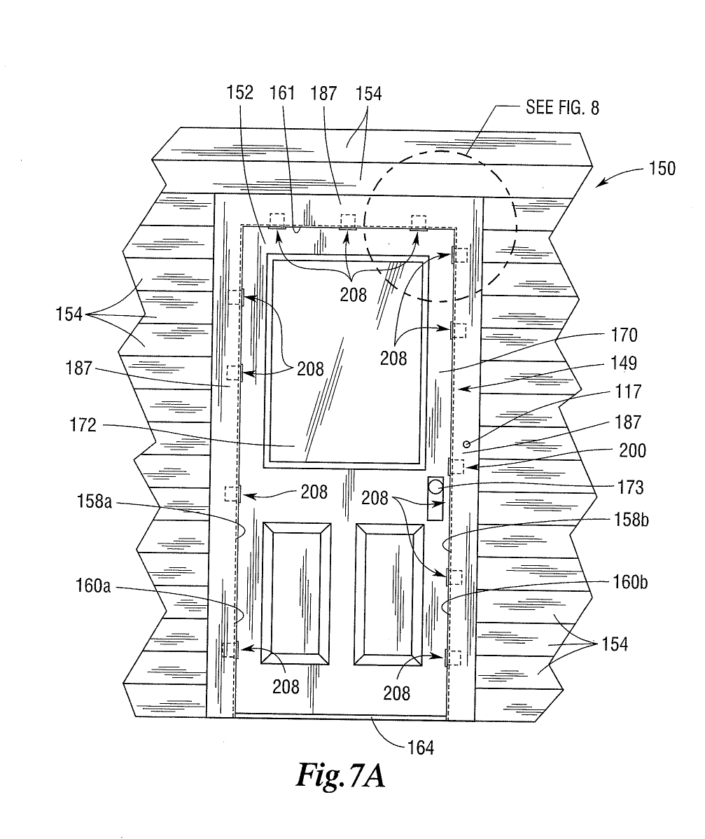

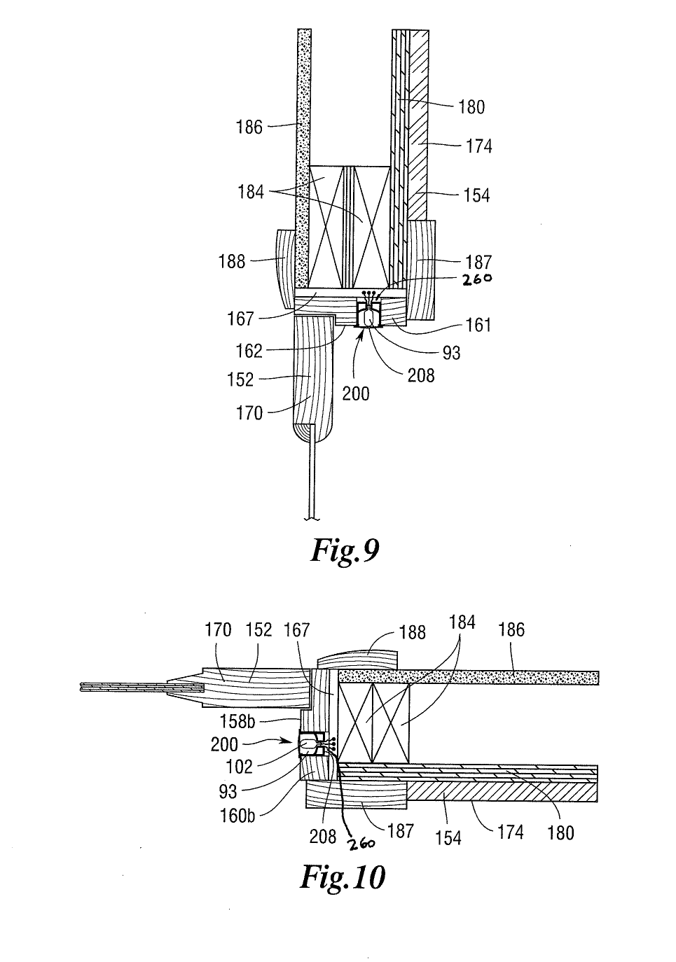

To use the system 200, openings 260 or recesses are drilled or otherwise formed in the door jambs 158a, 158b, and optionally the header 161 (see FIGS. 9 and 10). The openings 260 may be in communication with the wall spaces 177 defined in the walls 174. It is pointed out that the openings 260 in the first door jamb 158a may be offset relative to the openings in the second door jamb 158b, so that each opening 260 in the jambs 158a, 158b, is a different distance from the header 161. The lamp housings 210 are pressed into openings 260 until the housing flange 236 abuts against the doorjambs 158a, 158b, or header 161. The conductor 103 extends into the wall space 177 and is in electrical communication with the power source, for example the battery 115. A friction fit between the surrounding wall 230 and adjacent header 161 or jamb 158a, 158b, may be used to retain the lamp housings 210 in place. Thus, the lighting assembly 208 is removably received in the opening 260. Or the lamp housings 210 may held in place with an adhesive. The light emitting element 102 in this illustrative example is an incandescent bulb, and is shown secured in the socket assembly 222. The transmittive-protective cover member 242 may be pressed onto the housing flange 236. After installation, the lighting assemblies 208 mounted in the first doorjamb 158a face in a direction toward the second doorjamb 158b, and the lighting assemblies 208 mounted in the second doorjamb 158b face in a direction toward the first doorjamb 158a. The lighting assemblies 208 mounted in the first doorjamb 158a may be at distances from the header 161 that are different than the distances the lighting assemblies 208 mounted in the second doorjamb 158b are from the header 161 (see FIG. 7A). If provided, the lighting assembly 208 mounted in the header 161 faces the threshold 164. The light emitting elements 102 may be low power in order to conserve electricity and achieve a more even illumination of the first and second door jambs 158, 158b, door 152 and threshold 164.

In another embodiment, the header 161 does not have any recessed lighting assemblies 208, and the first and second door jambs 158a, 158b have lighting assemblies 208. For example, there may be four lighting assemblies 208 mounted in the first doorjamb 158a, and five lighting assembles 208 mounted in the second door jamb 158b, each being positioned a different distance from the header 161, and in this manner the light emitting elements 102 are offset from one another. The offset may reduce a scalloped effect on the door 152 and may provided a more even illumination of the door 152. The lighting assemblies 208 mounted in the first and second door jambs 158a, 158b can be maintained by a person standing on the ground, thereby eliminating the need for a ladder and making maintaining the recessed lighting assembly a safer operation.

It is pointed out that the first and second door jambs 158a, 158b, and header 161 and lighting assembly 208 may be pre-assembled at a factory (not shown), such that they are readily available for use during construction of the house 150.

The recessed entryway illumination system 200 can be used in the same manner as described in connection with the embodiment described above. In particular, when the switch 109 is closed, electric current flows to the lighting elements 102. The lighting assembly 208 joined to the first doorjamb 158a emits light which illuminates the second door jamb surface 160b, and to some extent, the door 152, threshold 164 and header 161. The lighting assembly 208 mounted in the second door jamb 158b emits light which illuminates the facing first door jamb surface 160a, and to some extent the header 161 and the threshold 164. The lighting assemblies 208 mounted in the header 161 emit light and illuminate the door 152, the first and second door jamb surfaces 160a, 160b and the threshold 164. Thus, one of the advantages of the recessed entryway illumination system 200 is that the entryway 149 is more fully illuminated by the lighting devices 208, which provides for an aesthetically pleasing and inviting entryway 149 that is more completely illuminated when compared to prior art illumination systems. As another advantage the doorknob 173 is illuminated making the opening and locking (and unlocking) of the door 152 easier. In addition, there may be a photocell switching device 117 mounted on the house wall 174 (see FIG. 7) that is in electronic communication with the switch 109. The photocell switching device 117 detects ambient light and turns the light emitting elements 102 on and off in accordance with the intensity or level of the ambient light detected.

The lamp housing 210 may have a circular cross section as described above, or may be embodied to have a rectangular-shaped cross section with a rectangular-shaped base. Other shapes are possible. The openings or recesses in the first and second door jambs 158a, 158b, respectively, and header 161 in such an embodiment would have similarly shaped cross sections so as to be able to receive the lamp housings. The transmittive-protective cover member 242 may be shaped to match the lamp housing 210. Thus, the recessed entryway illumination system 200 can be variously embodied to have differently shaped cross sections.

While the entryway illumination system has been described in connection with certain embodiments, it is not intended to limit the scope of the invention to the particular forms set forth. On the contrary, the invention is intended to cover such alternatives, modifications, and equivalents as may be included within the spirit and scope of the appended claims.

What is claimed is:

1. An entryway illumination system comprising:
a first jamb;
a second jamb;
a header extending between the first and second jambs; and
a lighting assembly mounted on one of the jambs wherein the lighting assembly includes a light emitting element.

2. The entryway illumination system according to claim 1, further including a lighting assembly mounted on the header.

3. The entryway illumination system according to claim 1 wherein the lighting assembly includes a lamp housing for protecting the light emitting element.

4. The entryway illumination system according to claim 3, further wherein the lighting assembly includes a mounting bracket with spaced apart first and second flanges and the lamp housing has first and second locking walls and the first and second flanges engage the first and second locking walls to join the mounting bracket and lamp housing.

5. The entryway illumination system according to claim 3 further, wherein the lamp housing includes a light transmittive-protective cover joined to the lamp housing.

6. The entryway illumination system according to claim 5, wherein the lamp housing further includes first and second lamp housing flanges that face third and fourth lamp housing flanges, and the transmittive-protective cover has first and second first securing walls with the first securing wall positioned between the first and the second lamp housing flanges and the second securing wall positioned between the third and fourth lamp housing flanges such that the transmittive-protective cover and lamp housing are joined.

7. The entryway illumination system according to claim 5 wherein the transmittive-protective cover has a color such that the when the light emitting element is energized, light that is the same as the color of the housing transmittive protective cover is emitted.

8. The entryway illumination system according to claim 1, wherein the light emitting element is directed to illuminate the jamb other than the jamb on which the lighting assembly is mounted.

9. The entryway illumination system according to claim 1, further including another lighting assembly with a light emitting element mounted on the other of the first and second jambs, and the lighting assemblies are mounted on their respective jambs so that the first jamb is illuminated by the lighting assembly mounted on the second jamb and the second jamb is illuminated by the lighting assembly mounted on the first jamb.

10. The entryway illumination system according to claim 9, wherein the lighting assemblies are differently distanced from the header.

11. The entryway illumination system according to claim 1, wherein the lighting assembly includes a reflective curved wall for reflecting light emitted by the light emitting element.

12. The entryway illumination system according to claim 1, further including a switch and a power source, and conductors electrically connecting the light emitting element to the switch and power source such that electricity can be selectively supplied from the power source to the light emitting element via the switch.

13. The entryway illumination system according to claim 1, wherein the light emitting element is one of one following: incandescent, fluorescent, fiber optic, light-emitting diode (LED), halogen and neon.

14. A method of illuminating an entryway comprising:
providing first and second jambs;
providing a header extending between the first and second jambs;
providing a lighting assembly having a light emitting element;
mounting the lighting assembly on one of the first and second jambs; and
illuminating the entryway with the lighting assembly.

15. The method according to claim 14, further including mounting another lighting assembly on the header.

16. The method according to claim 14, further including mounting another lighting assembly on the other of the first and second jambs and illuminating the first jamb with the lighting assembly mounted on the second jamb and illuminating the second jamb with the lighting assembly mounted on the first jamb.

17. The method according to claim 14 further including providing the lighting assembly with a lamp housing and a mounting bracket and joining the lamp housing and the mounting bracket to protect the light emitting element.

18. A recessed illumination system comprising:
a first jamb having an opening;
a second jamb;
a header extending between the first and second jambs; and
and a lighting assembly having a light emitting element, the lighting assembly residing in the opening.

19. The recessed entryway illumination system according to claim 18, wherein the header includes an opening and the illumination system further includes a lighting assembly received in the header opening.

20. The recessed entryway illumination system according to claim 18, wherein the lighting assembly includes a lamp housing with a transmittive-protective cover on the lamp housing.

21. The recessed entryway illumination system according to claim 18, further including another lighting assembly received in an opening in the other of the first and second jambs, and the lighting assemblies are mounted in their respectively jambs so that the first jamb is illuminated by the lighting assembly received in the second jamb and the second jamb is illuminated by the lighting assembly received in the first jamb.

22. The recessed entryway illumination system according to claim 21, wherein the lighting assemblies in the first and second jambs are differently distanced from the header.

23. A method of illuminating an entryway comprising:
providing a first jamb having an opening and a second jamb;
providing a header extending between the first and second jambs;
providing in the opening a lighting assembly having a light emitting element; and
illuminating the entryway with the lighting assembly.

24. The method according to claim 23, wherein the header includes an opening and the method further includes positioning a lighting assembly in the opening.

25. The method according to claim 23, wherein the second jamb has an opening and providing in the opening another lighting assembly, and illuminating the first jamb with the lighting assembly received in the second jamb and illuminating the second jamb with the lighting assembly received in the first jamb.
